(19) United States
(12) Patent Application Publication
(10) Pub. No.: US 2015/0185867 A1
(43) Pub. Date: Jul. 2, 2015

(54) KEYBOARD ASSEMBLY AND VOICE-RECOGNITION METHOD

(71) Applicants: HONG FU JIN PRECISION INDUSTRY (WuHan) CO., LTD., Wuhan (CN); HON HAI PRECISION INDUSTRY CO., LTD., New Taipei (TW)

(72) Inventors: DAO-WEI LI, Wuhan (CN); CHUN-SHENG CHEN, New Taipei (TW)

(21) Appl. No.: 14/523,091

(22) Filed: Oct. 24, 2014

(30) Foreign Application Priority Data
Dec. 30, 2013 (CN) 201310742009.5

(51) Int. Cl. G06F 3/02; G10L 25/72; G10L 21/16; G10L 15/00

(52) U.S. Cl. CPC G06F 3/0227; G10L 15/00; G10L 25/72; G10L 21/16

(57) ABSTRACT

A keyboard assembly with voice-recognition ability includes a keyboard module, a wireless transceiver chip, a voice-recognition chip, and a voice-receiver member. The chips and the member are mounted in the keyboard module. The keyboard module includes a keyboard body and a keyboard control processor mounted on the keyboard body. The keyboard control processor is configured to communicate with an electronic device. The keyboard body includes a plurality of keys. The voice-receiver member receives a voice instruction and sends the voice instruction to the voice-recognition chip. The voice-recognition chip can recognize the voice instruction as a key signal corresponding to one of the keys and sends the key signal to the wireless transceiver chip. The wireless transceiver chip sends the key signal to the electronic device. A voice-recognition method is also provided.

### CROSS-REFERENCE TO RELATED APPLICATIONS

This application claims priority to Chinese Patent Application No. 201310742009.5 Dec. 30, 2013, the contents of which are incorporated by reference herein.

### FIELD

The subject matter herein generally relates to a keyboard assembly.

### BACKGROUND

A keyboard assembly can be used to control an electronic device by voice-recognition.

### BRIEF DESCRIPTION OF THE DRAWINGS

Implementations of the present technology will now be described, by way of example only, with reference to the attached figures.

FIG. 1 is a block diagram of one embodiment of a keyboard assembly.

FIG. 2 is a circuit diagram of the keyboard assembly of FIG. 1.

FIG. 3 is a flowchart of one embodiment of a voice-recognition method.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, components have not been described in detail so as not to obscure the related relevant feature being described. Also, the description is not to be considered as limiting the scope of the embodiments described herein. The drawings are not necessarily to scale and the proportions of certain parts have been exaggerated to better illustrate details and features of the present disclosure.

Several definitions that apply throughout this disclosure will now be presented.

The term “coupled” is defined as connected, whether directly or indirectly through intervening components, and is not necessarily limited to physical connections. The connection can be such that the objects are permanently connected or releasably connected. The term “comprising,” when utilized, means “comprising, but not necessarily limited to”; it specifically indicates open-ended inclusion or membership in the so-described combination, group, series and the like.

The present disclosure is described in relation to a keyboard assembly for controlling an electronic device by voice-recognition.

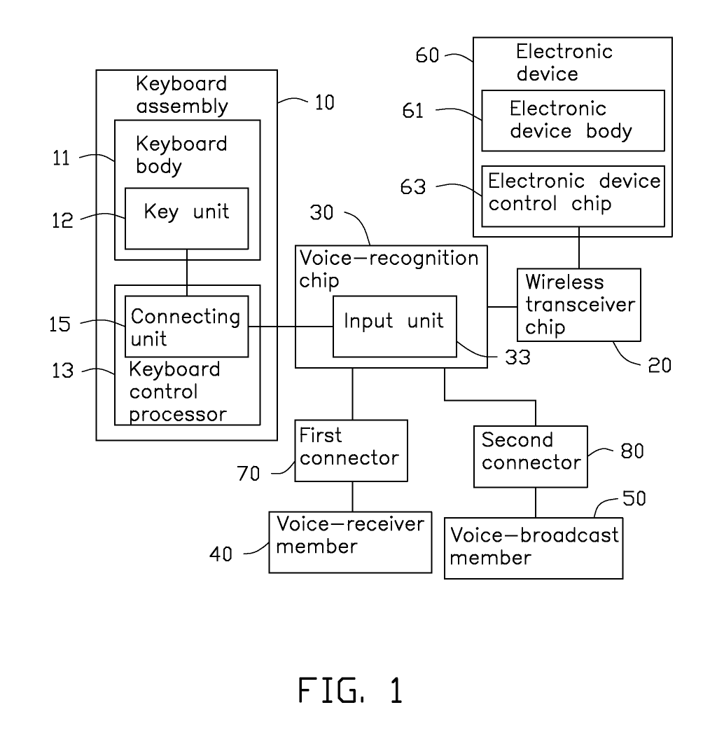

FIG. 1 illustrates an embodiment of a keyboard assembly. The keyboard assembly for controlling an electronic device 60 comprises a keyboard module 10, a wireless transceiver chip 20 mounted in the keyboard module 10, a voice-recognition chip 30 mounted in the keyboard module 10, a voice-receiver member 40 mounted in the keyboard module 10, and a voice-broadcast member 50. The voice-receiver member 40 is mounted on the voice-recognition chip 30 by a first connector 70. The voice-broadcast member 50 is mounted on the voice-recognition chip 30 by a second connector 80. In one embodiment, the electronic device 60 can be a TV set or a computer; a type of the wireless transceiver chip 20 is LT8900; a type of the voice-recognition chip 30 is ISD9160; the voice-receiver member 40 is a microphone and the voice-broadcast member 50 is a speaker.

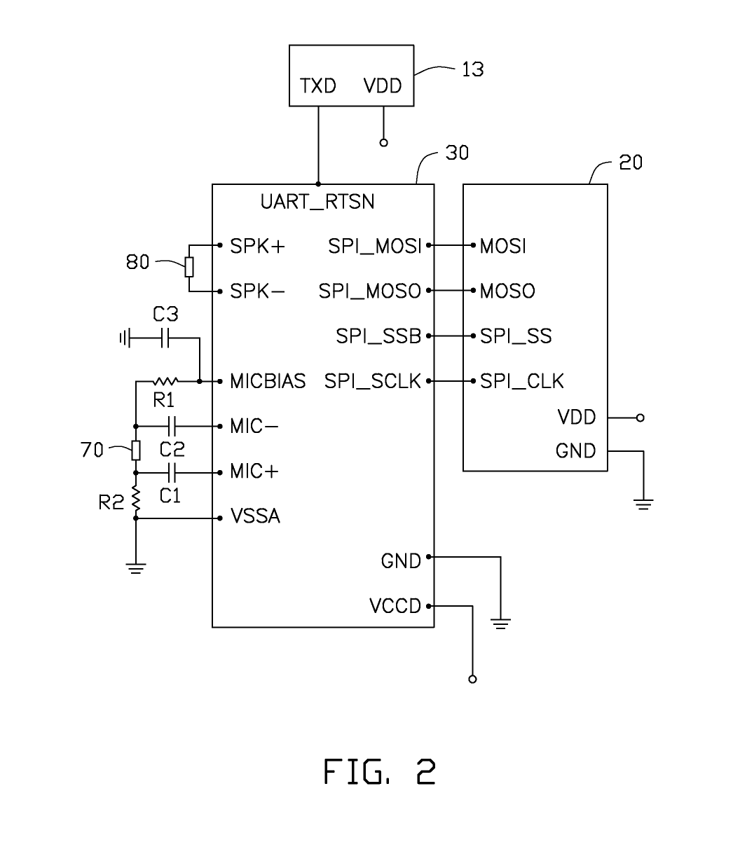

FIG. 2 illustrates that the electronic device 60 comprises an electronic device body 61 and an electronic device control chip 63 mounted on the electronic device body 61. The electronic device control chip 63 is configured to control the electronic device body 61.

The keyboard module 10 comprises a keyboard body 11 and a keyboard control processor 13 mounted in the keyboard body 11. The keyboard control processor 13 is configured to communicate with the electronic device control chip 63. The keyboard body 11 comprises a key unit 12. The key unit 12 comprises a plurality of keys (not shown).

The keyboard control processor 13 comprises a connecting unit 15 coupled to the key unit 12. The connecting unit 15 comprises a plurality of connecting ends (not shown) corresponding to the keys. The keyboard control processor 13 comprises a data receiving end TXD and a power supply end VDD. In one embodiment, a type of the keyboard control processor 13 is UR5HC703-600-FG.

The wireless transceiver chip 20 comprises an input end MOSI, an output end MOSO, a chip selecting signal end SPI_SS, a clock signal end SPI_CLK, a power supply end VDD, and a grounding end GND.

The voice-recognition chip 30 comprises an input pin SPI_MOSI, an output pin SPI_MOSO, a chip selecting signal pin SPI_SSB, a clock signal pin SPI_SCLK, a power supply pin VCCD and a grounding pin GND, a positive microphone input pin MIC+, a cathodic microphone input pin MIC−, a positive speaker output pin SPK+, a cathodic speaker output pin SPK−, a serial receiving pin UART_RTSN, a microphone bias output pin MICBIAS, an analog grounding pin VSSA, and an input unit 33. The input unit 33 comprises a plurality of input pins (not shown). The plurality of input pins of the input unit 33 is configured to couple to the plurality of connecting ends of the keyboard module 10.

The input end MOSI, the output end MOSO, the chip selecting signal end SPI_SS, and the clock signal end SPI_CLK of the wireless transceiver chip 20 are respectively coupled to the input pin SPI_MOSI, the output pin SPI_MOSO, the chip selecting signal pin SPI_SSB, and the clock signal pin SPI_SCLK of the voice-recognition chip 30. The power supply end VDD of the wireless transceiver chip 20, the power supply pin VCCD of the voice-recognition chip 30, and the power supply end VDD of the keyboard control processor 13 are coupled to a power supply (not shown). The grounding end GND of the wireless transceiver chip 20 and the grounding pin GND of the voice-recognition chip 30 are grounded. A positive pin of the first connector 70 is coupled to the microphone bias output pin MICBIAS of the voice-recognition chip 30 via a first resistance R1. The positive pin of the first connector 70 is coupled to the positive microphone input pin MIC+ of the voice-recognition chip 30 via a first capacitance C1. A cathodic pin of the first connector 70 is coupled to the cathodic microphone input pin MIC− of the voice-recognition chip 30 via a second capacitance C2. A positive pin and a cathodic pin of the voice-receiver member 40 respectively correspond to the positive pin and the cathodic pin of the first connector 70. The voice-receiver member 40 is mounted to the first connector 70. A positive pin and a cathodic pin of the voice-broadcast member 50 respectively correspond to the positive pin and the cathodic pin of the second connector 80. The voice-broadcast member 50 is mounted to the second connector 80. The positive pin and the cathodic pin of the voice-broadcast member 50 respectively correspond to the cathodic microphone input pin MIC− and the positive speaker output pin SPK+ of the voice-recognition chip 30. The serial receiving pin UART RTSN of the voice-recognition chip 30 is coupled to the data receiving end TXD of the keyboard control processor 13. The positive pin of the first connector 70 is coupled to the analog grounding pin VSSA of the voice-recognition chip 30 via a second resistance R2. The positive pin of the first connector 70 is grounded via the second resistance R2. The microphone bias output pin MICBIAS of the voice-recognition chip 30 is grounded via a third capacitance C3. The plurality of the input pins of the input unit 33 is coupled to the plurality of connecting ends of the connecting unit 15.

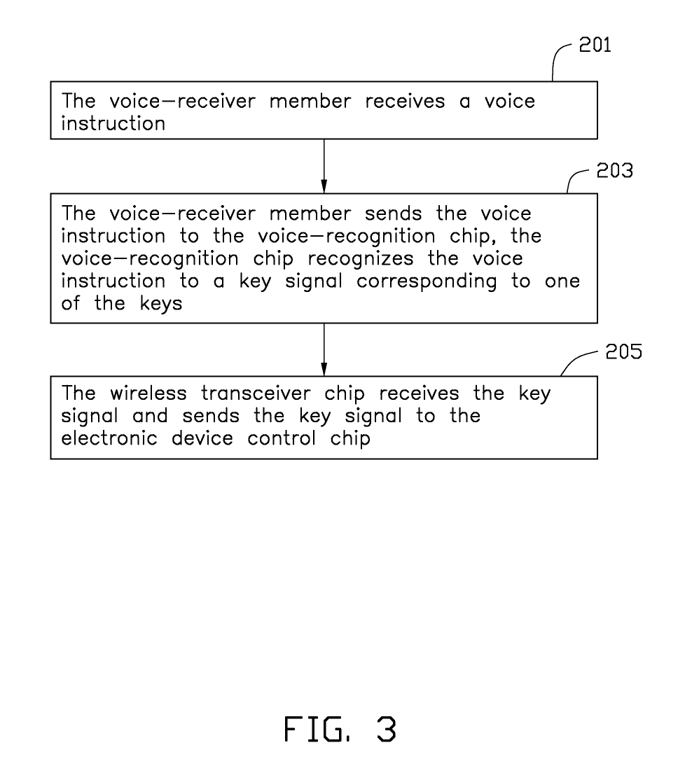

FIG. 3 illustrates a flowchart in accordance with an example embodiment. A voice-recognition method is provided by way of example, as there are a variety of ways to carry out the method. The voice-recognition method described below can be carried out using the configurations illustrated in FIGS. 1 and 2, for example, and various elements of these figures are referenced in explaining voice-recognition method. Each block shown in FIG. 3 represents one or more processes, methods, or subroutines carried out in the voice-recognition method. Additionally, the illustrated order of blocks is by example only and the order of the blocks can change. The voice-recognition method can begin at block 201.

In block 201, the voice-receiver member receives a voice instruction.

In block 203, the voice-receiver member 40 sends the voice instruction to the voice-recognition chip 30, the voice-recognition chip 30 recognizes the voice instruction as a key signal corresponding to one of the keys.

In block 205, the wireless transceiver chip 20 receives the key signal and sends the key signal to the electronic device control chip 63.

In one embodiment, the voice-broadcast member 50 receives the key signal from the voice-recognition chip 30 and audibly repeats the voice instruction corresponding to the key signal when a user controls the electronic device 60 by voice. A user can hear whether his voice instruction is as intended by listening to the voice instruction.

In another embodiment, the keyboard module 10 can be operated by users to communicate with the electronic device 60. Users can press any keys of the keyboard module 10. The keyboard control processor 13 is triggered to send a key signal to the voice-recognition chip 30 when a key is pressed. The voice-recognition chip 30 sends the key signal to the wireless transceiver chip 20. The wireless transceiver chip 20 sends the key signal to the electronic device control chip 63. The electronic device control chip 63 controls the electronic device body 61 according to the key signal.

It is to be understood that even though numerous characteristics and advantages have been set forth in the foregoing description of embodiments, together with details of the structures and functions of the embodiments, the disclosure is illustrative only and changes may be made in detail, especially in the matters of shape, size, and arrangement of parts within the principles of the disclosure to the full extent indicated by the broad general meaning of the terms in which the appended claims are expressed.

What is claimed is:

1. A keyboard assembly with voice-recognition ability comprising:
a keyboard module with:
a keyboard body having a plurality of keys, and
a keyboard control processor configured to communicate with an electronic device,
a wireless transceiver chip,
a voice-recognition chip, and
a voice-receiver member;
wherein, the voice-receiver member is configured to send a voice instruction to the voice-recognition chip;
the voice-recognition chip is configured to recognize the voice instruction as a key signal and send the key signal to the wireless transceiver chip after receiving the voice instruction; and
the wireless transceiver is configured to send the key signal to the electronic device after receiving the key signal.

2. The keyboard assembly of claim 1, further comprises a voice-broadcast member, wherein the voice-broadcast member audibly repeats the voice instruction.

3. The keyboard assembly of claim 2, wherein the voice-broadcast member is a speaker.

4. The keyboard assembly of claim 1, wherein the keyboard module comprises a keyboard control processor, the keyboard control processor can be triggered to send the key signal to the voice-recognition chip when one of the keys is pressed, the voice-recognition chip sends the key signal to the wireless transceiver chip when receiving the key signal, and the wireless transceiver chip sends the key signal to the electronic device.

5. The keyboard assembly of claim 1, wherein the voice-receiver member comprises a positive pin and a cathodic pin, the voice-recognition chip comprises a positive microphone input pin and a cathodic microphone input pin, the positive pin of the voice-receiver member is coupled to the positive microphone input pin of the voice-recognition chip via a first capacitance, the cathodic pin of the voice-receiver member is coupled to the cathodic microphone input pin of the voice-recognition chip via a second capacitance.

6. The keyboard assembly of claim 5, wherein the voice-recognition chip further comprises a microphone bias output pin, the positive pin of the voice-receiver member is coupled to the microphone bias output pin of the voice-recognition chip via a first resistance.

7. The keyboard assembly of claim 6, wherein the microphone bias output pin of the voice-recognition chip is grounded via a third capacitance.

8. The keyboard assembly of claim 6, wherein the voice-recognition chip further comprises an analog grounding pin, the positive pin of the voice-receiver member is coupled to one end of the second resistance via the first capacitance, the other end of the second resistance is coupled to the analog grounding pin of the voice-recognition chip.

9. The keyboard assembly of claim 5, wherein the positive pin of the voice-receiver member corresponds to a positive pin of a connector, the cathodic pin of the voice-receiver member corresponds to a cathodic pin of the connector, the voice-receiver member is mounted to the connector.

10. The keyboard assembly of claim 5, wherein the positive pin of the voice-receiver member corresponds to a positive pin of a connector, the cathodic pin of the voice-receiver member corresponds to a cathodic pin of the connector, the voice-receiver member is mounted to the connector.

11. A keyboard assembly with voice-recognition ability comprising:
a keyboard module with:
a keyboard body having a plurality of keys, and
a keyboard control processor mounted on the keyboard body and configured to communicate with an electronic device,
a wireless transceiver chip mounted in the keyboard module,
a voice-recognition chip mounted in the keyboard module, and
a voice-receiver member mounted in the keyboard module;
wherein, the voice-receiver member receives a voice instruction and sends the voice instruction to the voice-recognition chip;
the voice-recognition chip recognizes the voice instruction as a key signal corresponding to one of the keys and sends the key signal to the wireless transceiver chip after receiving the voice instruction; and
the wireless transceiver sends the key signal to the electronic device after receiving the key signal.

12. The keyboard assembly of claim 11, further comprises a voice-broadcast member, wherein the voice-broadcast member audibly repeats the voice instruction.

13. The keyboard assembly of claim 11, wherein the voice-receiver member is a microphone.

14. The keyboard assembly of claim 11, wherein the keyboard module comprises a keyboard body and a keyboard control processor mounted in the keyboard body, the plurality of keys are on the keyboard body, the keyboard control processor can be triggered to send the key signal to the voice-recognition chip when one of the keys is pressed, the voice-recognition chip sends the key signal to the wireless transceiver chip when receiving the key signal, and the wireless transceiver chip sends the key signal to the electronic device.

15. The keyboard assembly of claim 14, wherein the voice-receiver member comprises a positive pin and a cathodic pin, the voice-recognition chip comprises a positive microphone input pin and a cathodic microphone input pin, the positive pin of the voice-receiver member is coupled to the positive microphone input pin of the voice-recognition chip via a first capacitance, the cathodic pin of the voice-receiver member is coupled to the cathodic microphone input pin of the voice-recognition chip via a second capacitance.

16. The keyboard assembly of claim 15, wherein the voice-recognition chip further comprises a microphone bias output pin, the positive pin of the voice-receiver member is coupled to the microphone bias output pin of the voice-recognition chip via a first resistance, and the microphone bias output pin of the voice-recognition chip is grounded via a third capacitance.

17. The keyboard assembly of claim 16, wherein the voice-recognition chip further comprises an analog grounding pin, the positive pin of the voice-receiver member is coupled to one end of the second resistance via the first capacitance, the other end of the second resistance is coupled to the analog grounding pin of the voice-recognition chip.

18. The keyboard assembly of claim 14, wherein the positive pin of the voice-receiver member corresponds to a positive pin of a connector, the cathodic pin of the voice-receiver member corresponds to a cathodic pin of the connector, the voice-receiver member is mounted to the connector.

19. A voice-recognition method comprising:
sending a voice instruction to the voice-receiver member;
sending the voice instruction to the voice-recognition chip by the voice-receiver member, recognizing the voice instruction as a key signal corresponding to one of the keys by the voice-recognition chip; and
receiving the key signal and sending the key signal to the electronic device control chip by the wireless transceiver chip.

20. The voice-recognition method of claim 19, further comprising a step of audibly repeating the voice instruction by a voice-broadcast member after recognizing the voice instruction as a key signal corresponding to one of the keys by the voice-recognition chip.
